(19) United States
(12) Patent Application Publication
(10) Pub. No.: US 2025/0246035 A1
(43) Pub. Date: Jul. 31, 2025

(54) SYSTEM CONSISTING OF A VEHICLE AND A MOBILE DEVICE FOR UNLOCKING THE VEHICLE AND/OR FOR ENABLING A FUNCTION OF THE VEHICLE

(71) Applicant: MARQUARDT GMBH, Rietheim-Weilheim (DE)

(72) Inventors: Fabian FURTWAENGLER, Löffingen (DE); Jörg FISCHER, Donaueschingen (DE); Andreas KOCH, Rietheim-Weilheim (DE); Bernd BÄR, Rottweil (DE)

(21) Appl. No.: 18/856,993

(22) PCT Filed: Feb. 28, 2023
(86) PCT No.: PCT/EP2023/054933

§ 371 Date: Oct. 15, 2024

(30) Foreign Application Priority Data
Apr. 21, 2022 (DE) 10 2022 109 616.5

(51) Int. Cl. G07C 9/00

(52) U.S. Cl. CPC G07C 9/00309; G07C 2009/00325

(57) ABSTRACT

A system (1) has a vehicle (2) and a mobile device (3) to unlock the vehicle (2) and/or enable a function of the vehicle (2). The vehicle (2) has at least one first transceiver (A) that is designed to transmit and receive data wirelessly. The mobile device (3) has at least one second transceiver (B) that is designed to transmit and receive data wirelessly. The first transceiver (A) and the second transceiver (B) are designed to establish a wireless connection with one another as connection partners that enables data exchange. The first transceiver (A) is designed to check an environment of the vehicle (2) for available connection partners. The second transceiver (B) is designed to signal its availability as a connection partner.

### CROSS-REFERENCE TO RELATED APPLICATIONS

This application is a 371 U.S. National Phase of International Application No. PCT/EP2023/054933, filed on Feb. 28, 2023 and also claims the benefit of German Application No. 10 2022 109 616.5, filed on Apr. 21, 2022. The entire disclosures of the above applications are incorporated herein by reference.

### DESCRIPTION

The disclosure relates to a system consisting of a vehicle and a mobile device for unlocking the vehicle and/or for enabling a function of the vehicle.

Numerous systems consisting of a vehicle and a mobile device are already known in the art in which the vehicle can be unlocked by the mobile device or a function of the vehicle can be enabled or triggered by the mobile device. In the current state of the art, wireless keys or mobile phones can be used as mobile devices.

There is a fundamental problem, however, in that the necessary radio connection between the vehicle and the mobile device requires a relatively high amount of energy from the mobile device, so that its battery must be large or it will run out relatively quickly.

This means that mobile devices are subject to certain limitations and have to be correspondingly large.

In particular, it is usually not possible to provide a comparatively small key fob that assumes the function of such a mobile device and can also be referred to as a smart fob.

It is therefore the object of the disclosure to overcome the aforementioned drawbacks and provide a system consisting of a vehicle and a mobile device for unlocking the vehicle and/or for enabling a function of the vehicle with the lowest possible energy requirement on the part of the mobile device.

This object is achieved by the combination of features according to claim 1.

A system is therefore proposed according to the disclosure which consists of a vehicle and a mobile device for unlocking the vehicle and/or for enabling a function of the vehicle. The enabling of a function of the vehicle can also be understood here as the triggering of a function of the vehicle. The vehicle has at least one first transceiver which is particularly designed to transmit and receive data wirelessly, i.e., by radio. Furthermore, the mobile device has at least one second transceiver which is particularly designed to transmit and receive data wirelessly, i.e., by radio. The first transceiver and the second transceiver are designed to act as connection partners to establish a wireless connection with each other that enables data exchange. In the current art, a provision is usually made that the mobile device searches for its connection partner and serves as the master or central point (scanning or scanning role) and the vehicle signals its availability accordingly (advertising or advertising role). However, this requires the mobile device to expend a comparatively large amount of energy. According to the disclosure, it is now proposed to swap the roles so that the first transceiver, i.e., the vehicle, is designed to check an environment of the vehicle or its environment for available connection partners (scanning). Accordingly, the disclosure makes a provision that the second transceiver, i.e., the mobile device, is designed to signal its availability as a connection partner (advertising). This preferably only applies until the connection is established, since neither scanning nor advertising is necessary afterward.

By virtue of the fact that, unlike in the prior art, the mobile device takes over the advertising and no energy-intensive scanning is required, a battery with a correspondingly reduced installation space requirement can be provided to supply the second transceiver in the mobile device and thus the entire mobile device.

The transceiver or the two transceivers need not be limited to a specific radio protocol. For example, the first transceiver and the second transceiver may each be NFC and/or BLE and/or UWB transceivers.

In particular, if the first and second transceivers are embodied as BLE transceivers, the second transceiver is designed to broadcast advertiser events on at least one advertiser channel, and the first transceiver is designed to check at least one advertiser channel for advertiser events and, upon receipt of an advertiser event, to establish a connection with the second transceiver transmitting the advertiser event.

The mobile device can, for example, be a vehicle key or a key fob or a mobile phone. Since a key fob can unlock the vehicle or enable or trigger functions of the vehicle, it can also be referred to as a so-called “smart fob.”

To improve the transmission power and also to identify a position of the mobile device, the first transceiver, i.e., the vehicle, can have at least one external unit for transmitting and receiving data on the exterior of the vehicle and an internal unit for transmitting and receiving data in the interior of the vehicle. The first transceiver can therefore have two subunits, each of which can be designed to establish a connection with the first transceiver. Alternatively, the first transceiver may have only two antennas, of which a first antenna is arranged in the interior of the vehicle (interior) and a second antenna is arranged outside the vehicle (exterior). The first transceiver is preferably designed to determine via which of the two antennas the second transceiver is connected to the first transceiver.

Furthermore, one advantageous variant makes a provision that the second transceiver, i.e., the mobile device or an evaluation unit of the mobile device connected thereto, is designed to determine a distance of the second transceiver from the first transceiver and/or a relative position of the second transceiver to the first transceiver and/or the vehicle, which can be achieved, for example, by evaluating the signal strength and/or through a connection to the external unit or the internal unit of the vehicle. A provision is also made that the evaluation unit is designed to switch between different transmission protocols and/or between different intervals in which signals are transmitted between the connection partners as a function of the distance and/or the position of the transceivers relative to one another.

For example, the second transceiver can be configured to transmit a signal via BLE every 0.3 seconds outside the vehicle and every 2 seconds inside the vehicle.

If transmission via UWB is used, for example, a signal can be transmitted every 0.3 seconds if the distance between the transceivers is less than 10 m and every 0.9 seconds if the distance is greater than 10 m.

If transmitting via NFC, the vehicle can provide energy via the radio signal so that the mobile device does not have to use any energy for this.

Since conventional mobile devices should also be able to be used to unlock the vehicle and/or enable a function of the vehicle, which accordingly do not take on the advertising role but rather the scanning role, an advantageous further development also makes a provision that the system further comprises a second mobile device with a third transceiver, the third transceiver being designed to transmit and receive data wirelessly. The first transceiver and the third transceiver are designed to establish a connection with each other as connection partners that enables data exchange, whereas the third transceiver is designed to check its environment for available connection partners and the first transceiver is designed to signal its availability as a connection partner.

Accordingly, it is possible, for example, for both a mobile phone to be used in the scanning role and a smart fob to be used in the advertising role which can connect independently of each other to the vehicle, which or whose transceiver supports both scanning and advertising.

The third transceiver can likewise be an NFC and/or BLE and/or UWB transceiver.

The first transceiver or the vehicle is preferably designed to simultaneously check the environment of the vehicle for available connection partners and to signal its availability as a connection partner, or to alternately check the environment of the vehicle for available connection partners and to signal its availability as a connection partner. This means that scanning and advertising are carried out alternately or simultaneously.

The first transceiver can be configured to process the data received from the first and second mobile devices, to process data received from the second transceiver and data received from the third transceiver simultaneously or according to a prioritization transmitted by the data or predetermined by the associated transceiver.

To further reduce the energy consumption of the first mobile device, it can also have a motion sensor which switches the mobile device from an operating mode to a sleep mode after a predetermined period of inactivity without any movement being detected and only switches it back from sleep mode to the operating mode when movement is detected again.

Another aspect of the disclosure relates to a mobile device which is particularly embodied as a smart fob and can correspond to the first mobile device of the system. The mobile device is particularly characterized in that it is designed to take on the advertising role itself and the second transceiver is designed to signal its availability as a connection partner

The features disclosed above can be combined as required, provided this is technically possible and they do not contradict one another.

Other advantageous refinements of the disclosure are characterized in the subclaims and/or depicted in greater detail below together with the description of the preferred embodiment of the invention with reference to the figures. In the drawing:

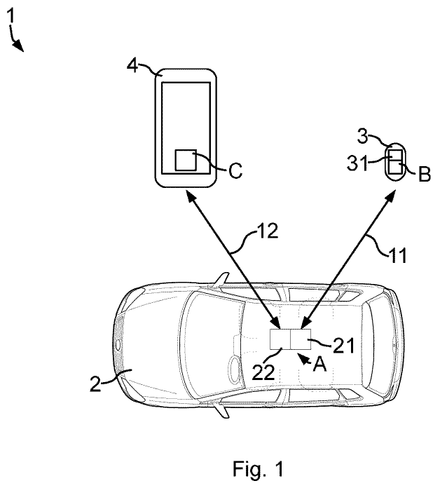

FIG. 1 shows a schematic view of the system.

Conventionally, the mobile device takes on the scanning role and the vehicle takes on the advertising role for establishing the connection. However, if a smart fob is to be used as a mobile device instead of a mobile phone, for example, it is impractical to transfer the scanning role to the smart fob due to the high power consumption required, since the high power consumption results in a space-intensive battery or a short battery life.

FIG. 1 shows an exemplary and schematic variant according to the disclosure in where the system 1 is composed of a vehicle 2 and a first mobile device 3.

The vehicle 2 and the (first) mobile device 3 each have a transceiver A, B, the first transceiver A of the vehicle 2 being designed to take on the scanning role and the second transceiver B of the smart fob or first mobile device 3 being designed to take on the advertising role and thereby establish a BLE connection 11 with each other.

If the vehicle 2 is to continue to be connectable to or unlockable by conventional mobile devices which themselves take on the scanning role, the first transceiver A can also be designed to take on the advertising role. The first transceiver A can have a scanning unit 21 and an advertising unit 22 for this purpose which can each connect to a corresponding mobile device 3, 4. Accordingly, in such a case, the system 1 may comprise another or second mobile device 4, such as a mobile phone, which provides a third transceiver C which is designed to take over the scanning role.

This allows the vehicle 2 to simultaneously establish the first BLE connection 11 with the first mobile device 3 and a second BLE connection 12 with the second mobile device 4.

The vehicle or the first transceiver A thus supports scanning and advertising in parallel, with the first transceiver A either switching between the roles or supporting them simultaneously.

Both functions (scanning and advertising) are necessary in order to enable the use of both the smart fob (first mobile device 3) and the mobile phone (second mobile device 4) while minimizing the power consumption of the smart fob (first mobile device 3).

Furthermore, the first mobile device 3 can have an evaluation unit 31 which can evaluate the signal strength or the transmitted signal and thereby determine the positioning relative to the vehicle 2 and/or a distance from the vehicle 2. Based on the distance and/or positioning, different transmission protocols and/or transmission intervals can then be used to further minimize the energy consumption in the first mobile device 3.

1-12. (canceled)

13. A system comprising:
a vehicle and a mobile device for unlocking the vehicle and/or enabling a function of the vehicle,
the vehicle has at least one first transceiver,
the mobile device has at least one second transceiver,
the first transceiver and the second transceiver are designed to establish a wireless connection with one another as connection partners that enables data exchange,
the first transceiver is designed to check an environment of the vehicle for available connection partners;
and the second transceiver is designed to signal its availability as a connection partner.

14. The system according to claim 13,
wherein the first transceiver and the second transceiver are each NFC and/or BLE and/or UWB transceivers.

15. The system according to claim 13,
wherein the second transceiver is designed to broadcast advertiser events on at least one advertiser channel,
and the first transceiver is designed to check at least one advertiser channel for advertiser events and, upon receipt of an advertiser event, to establish a connection with the second transceiver transmitting the advertiser event.

16. The system according to claim 13,
wherein the mobile device is a vehicle key or a key fob or a mobile phone.

17. The system according to claim 13,
wherein the first transceiver has at least one external unit for transmitting and receiving data on the exterior of the vehicle and an internal unit for transmitting and receiving data in the interior of the vehicle.

18. The system according to claim 13,
wherein the second transceiver or an evaluation unit of the mobile device connected thereto is designed to determine a distance of the second transceiver from the first transceiver and/or a relative position of the second transceiver to the first transceiver and/or the vehicle,
and, as a function of the distance and/or position, to switch between different transmission protocols and/or between different intervals where signals are transmitted between the connection partners.

19. The system according to claim 13,
further comprising a second mobile device with a third transceiver which is designed to transmit and receive data wirelessly,
the first transceiver and the third transceiver are designed to establish a connection with each other as connection partners that enables a data exchange,
the third transceiver is designed to check its environment for available connection partners
and the first transceiver is designed to signal its availability as a connection partner.

20. The system according to claim 19,
wherein the third transceiver is an NFC and/or BLE and/or UWB transceiver.

21. The system as set forth in claim 19,
wherein the second mobile device is a mobile phone.

22. The system according to claim 19,
wherein the first transceiver is designed to simultaneously check the environment of the vehicle for available connection partners and to signal its availability as a connection partner
or to alternately check the environment of the vehicle for available connection partners and to signal its availability as a connection partner.

23. The system according to claim 19,
wherein the first transceiver is designed to process data received from the second transceiver and data received from the third transceiver simultaneously or according to a prioritization transmitted by the data or predetermined by the associated transceiver.

24. A mobile device for unlocking the vehicle and/or enabling a function of the vehicle,
the vehicle has at least one first transceiver which is designed to transmit and receive data wirelessly,
the mobile device has at least one second transceiver which is designed to transmit and receive data wirelessly,
the second transceiver is designed to establish a wireless connection enabling a data exchange with the first transceiver as a connection partner, and
the second transceiver is designed to signal its availability as a connection partner.
